(19) United States
(12) Patent Application Publication
(10) Pub. No.: US 2026/0346462 A1
(43) Pub. Date: Nov. 5, 2026

(54) ROBOT CONTROL SYSTEM AND ROBOT CONTROL METHOD

(71) Applicant: TOYOTA JIDOSHA KABUSHIKI KAISHA, Toyota-shi (JP)

(72) Inventors: Osamu TANIAI, Okazaki-shi (JP); Yoshiki UEDA, Nagakute-shi (JP); Shiro ODA, Anjo-shi (JP)

(73) Assignee: TOYOTA JIDOSHA KABUSHIKI KAISHA, Toyota-shi (JP)

(21) Appl. No.: 19/539,349

(22) Filed: Feb. 13, 2026

(30) Foreign Application Priority Data
Mar. 18, 2025 (JP) 2025-043839

(51) Int. Cl. B25J 9/16

(52) U.S. Cl. CPC B25J 9/1697; B25J 9/1664

(57) ABSTRACT

A robot control system with different positions of waypoints according to the present disclosure is a robot control system that controls a plurality of types of autonomous movement robots, in which the robot control system sets a plurality of waypoints that are candidates for a via point of the autonomous movement robot on a map, searches for a route to a destination based on the plurality of waypoints, and controls the autonomous movement robot such that the autonomous movement robot sequentially passes through the waypoints to the destination, and positions of the waypoints are different depending on the autonomous movement robot. An AI model generated by machine learning such as supervised learning may be used for route planning, waypoint setting, or area setting.

### CROSS-REFERENCE TO RELATED APPLICATION

This application claims priority to Japanese Patent Application No. 2025-043839 filed on Mar. 18, 2025. The disclosure of the above-identified application, including the specification, drawings, and claims, is incorporated by reference herein in its entirety.

### BACKGROUND

### 1. Technical Field

The present disclosure relates to a robot control system and a robot control method.

### 2. Description of Related Art

Japanese Unexamined Patent Application Publication No. 2024-3200 (JP 2024-3200 A) discloses an information processing device that manages a group of robots that are movable. The information processing device acquires a map in which a passable region and an impassable region for the robots that are movable are distinguished, and information on sizes of the robots. The information processing device divides the passable region on the map into a first region in which an autonomous driving direction of the robots is determined and a second region in which the autonomous driving direction of the robots is not determined. Information indicating whether the robots can pass each other is generated using the information on the sizes of the robots.

### SUMMARY

In such a device of a moving object, there is a demand for controlling a plurality of robots such that the robots can move efficiently.

A robot control system according to the present disclosure is a robot control system that controls a plurality of kinds of autonomous movement robots, in which the robot control system is configured to
set, on a map, a plurality of waypoints serving as candidates for via points of the autonomous movement robots,
search for a route to a destination based on the waypoints, and
control the autonomous movement robots such that the autonomous movement robots sequentially pass through the waypoints to the destination, and
positions of the waypoints are different depending on the autonomous movement robots.

A robot control method according to the present disclosure is a robot control method that controls a plurality of kinds of autonomous movement robots, the robot control method including:
setting, on a map, a plurality of waypoints serving as candidates for via points of the autonomous movement robots;
searching for a route to a destination based on the waypoints; and
controlling the autonomous movement robots such that the autonomous movement robots sequentially pass through the waypoints to the destination,
in which positions of the waypoints are different depending on the autonomous movement robots.

According to the present disclosure, it is possible to provide the robot control system and the robot control method that can control the robots to move efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an overall configuration of a control system according to the present embodiment;

FIG. 2 is a block diagram showing a control system of a control device;

FIG. 3 is a diagram illustrating a restricted area and a waypoint set in map information of a facility; and

FIG. 4 is a flowchart showing a control method according to the present embodiment.

### DETAILED DESCRIPTION OF EMBODIMENTS

Hereinafter, the present disclosure will be described with an embodiment of the present disclosure, but the disclosure according to the claims is not limited to the following embodiment. Moreover, not all of the configurations described in the embodiments are indispensable as means for solving the problem.

### Overall Configuration

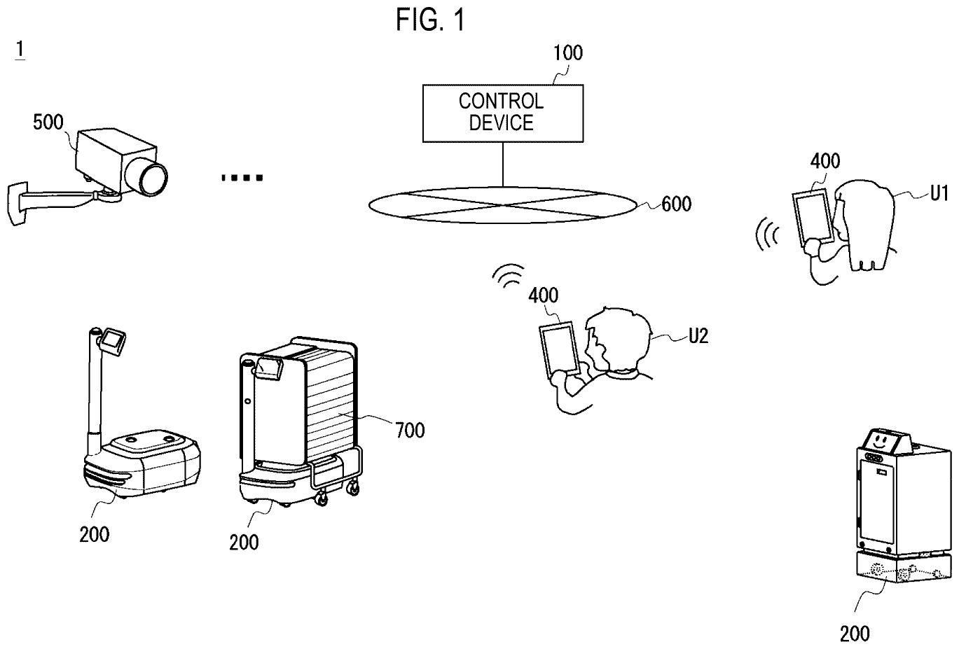

The control system according to the present embodiment is a system for managing an autonomous moving object. FIG. 1 is a schematic diagram showing a configuration of a control system 1. The control system 1 includes a control device 100, a robot 200, a camera 500, a network 600, a user terminal 400, and an accessory unit 700. The control system 1 is a system for managing a plurality of robots 200. The control device 100 manages passage and a task of the plurality of robots 200.

The robot 200 is an autonomous moving object that executes a task such as a transport task. The robot 200 autonomously moves in a medical and welfare facility such as a hospital, a rehabilitation center, a care facility, and a senior living facility. The robot 200 is used for transporting medicines, medical devices, meals, tableware, medical records, supplies, specimens, linens, people, and the like. The transport target may be a person such as a patient. In addition, the system according to the present embodiment can also be used in a commercial facility or the like, such as a shopping mall. The robot 200 includes wheels, a vehicle frame, a motor, a sensor, a battery, a controller, and the like.

The robot 200 is equipped with a distance measurement sensor such as LiDAR. The distance measurement sensor measures a distance to a peripheral object such as an object or a person around the robot 200. The robot 200 performs autonomous driving without coming into contact with the peripheral object around the robot 200. For example, the robot 200 has a virtual bumper function. In the virtual bumper function, in a case where the peripheral object approaches the robot 200 by a predetermined distance or less, the robot 200 decelerates or stops.

At least one of the robots 200 is a robot of a different type. All of the robots 200 may be the same type of robot. Each of the robots 200 is assigned a unique identification number (ID). In FIG. 1, three robots 200 are shown, but the number of robots is not particularly limited as long as it is plural.

Further, at least one of the robots 200 may execute a task other than the transport task. Examples of the other tasks include a cleaning task, a security task, and a guidance task. The robot 200 may execute a plurality of tasks such as cleaning, security, and guidance using the accessory unit 700, or may execute a task alone. The robot 200 executes various tasks, for example, by using the accessory unit 700 in combination with the robot 200. Different accessory units may be prepared for the robot 200 depending on the task. By replacing the accessory unit 700, the robot 200 becomes a multitask robot that executes a plurality of tasks.

In a case of the transport task, the accessory unit 700 is a cart or a wagon with wheels on which a transport object is mounted. In a case of the cleaning task, the accessory unit 700 includes a vacuum cleaner that sucks up garbage and the like. In a case of the security task, the accessory unit 700 includes a sensor such as light detection and ranging (LiDAR) or a camera. In a case of the guidance task, the accessory unit 700 includes a signboard or a display. In the following description, the robot 200 will be mainly described as executing the transport task.

The user U1 or the user U2 can make a task request such as a transport request of the transport object using the user terminal 400. For example, the user terminal 400 is a tablet computer or a smartphone. The user terminal 400 may be an information processing device capable of wireless or wired communication.

In the present embodiment, the robot 200 and the user terminal 400 are connected to the control device 100 via the network 600. The network 600 is a wired or wireless local area network (LAN) or wide area network (WAN). Further, the control device 100 is connected to the network 600 in a wired or wireless manner. For communication between the devices, for example, a general communication standard such as Wi-Fi (registered trademark) can be used.

Various signals transmitted from the user terminals 400 of the users U1, U2 are temporarily sent to the control device 100 via the network 600, and are transmitted from the control device 100 to the target robot 200. Similarly, various signals transmitted from the robot 200 are temporarily sent to the control device 100 via the network 600, and are transmitted from the control device 100 to the target user terminal 400. The control device 100 is a server connected to each device, and collects data from each device. In addition, the control device 100 is not limited to a single physical device, and may have a plurality of devices that perform distributed processing. In addition, the control device 100 may be disposed in a distributed manner in an edge device such as the robot 200. For example, a part or all of the control system 1 may be mounted on the robot 200.

The robot 200 includes a drive motor, wheels, a battery, and the like. Further, the robot 200 includes a sensor such as a camera or LiDAR, and a calculation processing unit such as a processor. The robot 200 estimates a self-position based on a detection result of the sensor. The robot 200 autonomously moves on a route from a departure point to a destination on the map based on the self-position. The departure point is a current position of the robot, and the destination is a transport destination of the transport object. In addition, the route search may be performed via a transport source of the transport object or the like as a via point. The control device 100 may perform the route search from the departure point to the destination, or the robot 200 may perform the route search.

The user terminal 400 and the robot 200 may transmit and receive signals without passing through the control device 100. For example, the user terminal 400 and the robot 200 may directly transmit and receive signals by wireless communication. In addition, the control device 100 may collect data from the camera 500. The camera 500 is a surveillance camera, a security camera, or the like. Further, the control device 100 may collect data from a communication device or a sensor (not shown).

It is assumed that a plurality of types of robots 200 is used in the facility. The control device 100 assigns a task to each robot 200. Each robot 200 may execute the assigned task by mounting the accessory unit 700 corresponding to the assigned task. The task executed by the robot 200 may be input by the user U1 or the user U2, or may be scheduled in advance. For example, the user U1 or the like performs the task request by operating the user terminal 400. The user U1 or the like can input a type of the task to be executed. The user U1 or the like may input a region or a time slot in which the task is executed. The control device 100 creates a schedule for the robot 200 to efficiently execute the task.

The user U1 or the user U2 may request the transport task by operating the user terminal 400. In this case, the user U1 or the user U2 inputs information related to the transport object. Further, the user U1 or the user U2 may input scheduled arrival information indicating an arrival schedule of the transport object. The control device 100 assigns the robot that executes the transport task based on the scheduled arrival information. Then, the control device 100 transmits a control signal for the robot to execute the task. The control signal may include route information to the destination or transport object information indicating the transport object or the like.

In such an overall configuration, each element of the control system 1 can be distributed to the robot 200, the user terminal 400, and the control device 100 to construct the control system 1 as a whole. In addition, a substantial element for realizing the transport of the transport object can be collected in one device to be constructed.

### Control System

The control device 100 includes a server computer or the like, and performs calculation for controlling and managing the robot 200. The control device 100 can be implemented as, for example, a device capable of executing a program, such as a central processing unit (CPU) of a computer. The functions described below can also be realized by a program. The control device 100 manages the transported object and the robot 200 based on the transport object ID of the transport object and the robot ID of the robot 200, respectively.

For example, the control device 100 manages the schedules of the plurality of robots 200 such that the robots 200 can efficiently execute the task. For example, in a case where the control device 100 receives the task request from the user terminal 400 or the like, the control device 100 selects one robot 200 from the plurality of robots 200 and issues an instruction to the robot 200 to execute the task. Alternatively, the control device 100 instructs the robot 200 regarding which accessory unit 700 to use.

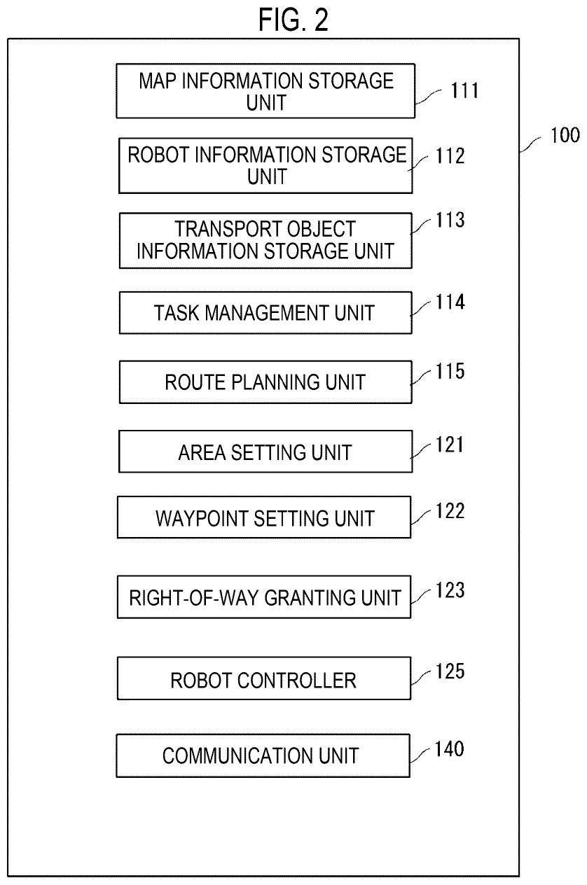

FIG. 2 is a block diagram showing a control system of the control device 100 according to the present embodiment. As shown in FIG. 2, the control device 100 includes a map information storage unit 111, a robot information storage unit 112, a transport object information storage unit 113, a task management unit 114, and a route planning unit 115. In addition, the control device 100 includes an area setting unit 121, a waypoint setting unit 122, a robot controller 125, and a communication unit 140. The functional blocks shown in FIG. 2 are examples, and the control device 100 may include other functional blocks. Alternatively, the control device 100 may not include a part of the functional blocks shown in FIG. 2. Further, some functions may be performed on the robot 200 side.

The map information storage unit 111 stores map information indicating a floor map (simply referred to as a map) of the facility. The map information may include information on a restricted area, a waypoint, and the like that will be described below. The map information may be created in advance. In addition, the map information may be map information including a partial region in which a service is scheduled to be executed, instead of a floor map of the entire facility. Each robot performs autonomous driving to the destination by referring to the map information. The map information may be generated based on an architectural drawing, computer-aided design (CAD) data, building information modeling (BIM) data, or the like. Alternatively, the map information may be generated based on a measurement result of a distance measurement sensor such as LiDAR.

The robot information storage unit 112 stores robot information. The robot information includes information on the robot 200 that is operating in the facility. The robot information includes information on a model number of the robot 200, a service that can be executed, a transport object type that can be transported, an accessory unit 700 that can be mounted, and the like. The robot information storage unit 112 stores the robot information in a database in which various types of information and the like are stored for each robot ID. The robot information may include a current position of the robot, a movement route, information indicating whether the robot is executing a task or is on a break, and information on the task being executed. The robot information may include information on an accessory unit in use or a transport object in transport.

The transport object information storage unit 113 stores transport object information related to the transport object. For example, the transport object information includes information such as an identification number (ID) of the transport object, a content (type) of the transport object, a transport source, a transport destination, a reception time, or an arrival time. The transport object information 126 is information indicating whether the transport object is a medicine, a medical device, a meal, tableware, a medical record, a supply, a specimen, a linen, a person, or the like. The transport object information 126 may include information such as a size or a weight of the transport object. The transport object information may include information indicating a status such as in transport, before transport (before mounting), and after transport. The transport object information storage unit 113 stores the transport object information in a database in which these pieces of information are associated with each other for each transport object ID. In a case where a new transport request of the transport object is received from the user terminal 400, the transport object information is added. In addition, after the transport is completed, the information related to the transport object may be deleted from the list.

The task management unit 114 manages the task executed by the robot 200. For example, the user U1 inputs the transport object information indicating the transport object, the transport source, the transport destination, and the like to request the transport task. The task management unit 114 assigns the transport task to the robot 200. For example, the task management unit 114 extracts the robot that can execute the task. For example, in a case where some of the robots 200 cannot transport the transport object requested for transport, the task management unit 114 extracts the robot 200 by excluding the robot 200.

The task management unit 114 extracts the robot 200 that can transport the transport object from among the plurality of robots 200. Then, the task management unit 114 assigns the transport task to the extracted robot 200. In a case where there are two or more robots that can transport the transport object, the task management unit 114 selects the robot such that the transport service can be executed more efficiently. For example, the task management unit 114 assigns the task to the robot that is near the transport source. Alternatively, the task management unit 114 assigns the task to the robot in an idle state in which another task is not being executed. In this way, the task can be efficiently executed.

The task management unit 114 manages the task executed, the task being executed, and the task scheduled to be executed by each robot 200. Further, the task management unit 114 may store various types of task information for each task in a database. The task management unit 114 may store information indicating whether each robot 200 is executing or has completed the task, as the task information. In addition, the task management unit 114 may store a transport start time at which the transport is started or a completion scheduled time at which the task being executed is completed, as the task information. The transport information related to the transport object in transport may be included in the task information. For example, the task information may include information such as a type of the transport object, a transport destination, and a transport source. Alternatively, the task management unit 114 may store information indicating whether the accessory unit 700 is in use.

The route planning unit 115 plans a route for executing the task. For example, the route planning unit 115 searches for a route from the transport source to the transport destination of the robot 200 to which the task is assigned. Specifically, a route from the current position of the robot 200 to the transport source is searched for. The transport source is a mounting place where the transport object is mounted. Further, the route planning unit 115 searches for a route from the transport source to the transport destination.

Waypoints set on the map are used for the route search. The waypoints are set on the map as candidates for the via points through which the robot passes. The waypoints will be described below. The route searched for by the route planning unit 115 is transmitted to the robot 200. At least a part of the processing of the route planning unit 115 may be executed by the robot 200. Further, in a case where a congested region is specified based on an image by a surveillance camera or the like, the route planning unit 115 may search for a route to avoid the congested region. The route planning unit 115 may search for a route that enables movement in the shortest time, the shortest distance, or the like.

In a case where the waypoints corresponding to the departure point, the destination, and the via point are input, the route planning unit 115 performs the route search. By the route search, the waypoints to be passed through and the passing order are specified. Then, the communication unit 140 transmits the ID information or the position of the waypoint to be passed through to the robot 200.

The area setting unit 121 divides the map into a plurality of areas. The area setting unit 121 sets a restricted area and a non-restricted area based on the plurality of areas. The area setting unit 121 sets the restricted area on the map. The restricted area is a region in which the movement of the robot 200 is restricted. For example, the restricted area is a region including an intersection or a branch point. Alternatively, a narrow passage through which the robot 200 cannot pass in both directions is a restricted area. In order for the robot 200 to pass through the restricted area, a right of way is needed. That is, the robot 200 to which the right of way is not granted cannot enter the restricted area and waits in front of the restricted area. The region other than the restricted area on the map is a non-restricted area. In the non-restricted area, the robot 200 can pass without the right of way. The area setting unit 121 sets one or a plurality of restricted areas on the map. In addition, the area setting unit 121 sets one or a plurality of non-restricted areas on the map.

The area setting unit 121 assigns an area ID to each of the restricted area and the non-restricted area. The area setting unit 121 stores the boundary line or the boundary coordinates in association with the area ID as the area information. The area information may include information indicating an attribute of the restricted area and the non-restricted area. For example, the attributes include a passage, an intersection, a branch point, an elevator hall, a hall, a room, an entrance and exit, a place to receive a package, a loading place, an unloading place, a waiting place, and a charging place. In addition, the area information may include information indicating the number of robots that can pass at the same time, and the like. The restriction on the passage is not limited to the prohibition of simultaneous passage, and may be one-way passage, one-side passage, or the like. In addition, the area setting unit 121 may change the area setting depending on a time slot or a situation.

For example, the area setting unit 121 divides each room into different areas. Then, the area setting unit 121 determines whether to set the area as the restricted area depending on the use, the size, the disposition, the layout, and the like of each room. The area setting unit 121 sets an intersection, a branch point, or the like of the passage as the restricted area. The area setting unit 121 sets a portion other than the intersection, the branch point, and the like as the non-restricted area. For example, the area setting unit 121 sets a straight portion of the passage as the non-restricted area.

The control device 100 or another computer may set the restricted area and the non-restricted area by calculation processing, or the user may set the restricted area and the non-restricted area. Further, after the restricted area or the non-restricted area is set by the calculation processing, the user may manually adjust the area setting. For example, one or more restricted areas or one or more non-restricted areas may be set by executing a program by a computer such as the control device 100. The user may manually set one or more restricted areas or one or more non-restricted areas.

By using a program for performing the area setting, the area setting can be easily performed. Specifically, the computer classifies the passage or the room based on the architectural drawing data, the map layout, and the BIM data. In a case where the computer specifies an intersection, a branch point, an entrance and exit, a waiting place, a corner, a narrow passage, or the like, the computer sets the place as the restricted area. An artificial intelligence (AI) model generated by supervised learning or the like can be used for the automatic setting of the area.

Image data indicating the architectural drawing or BIM data is input to a machine learning model. The machine learning model specifies a place where passage is not possible, such as a wall or an installation, by a segmentation algorithm, and classifies the room or the passage. The machine learning model determines whether to restrict the passage, and sets the restricted area. For example, the machine learning model sets a narrow passage, an entrance and exit, a waiting place, a branch point, and the periphery thereof as the restricted area. The machine learning model sets an area other than the restricted area on the map as the non-restricted area.

Of course, the area setting unit 121 may perform the area setting using an algorithm other than the model obtained by the machine learning. Alternatively, the autonomous driving of the robot may be monitored after the operation of the robot. In a case where a place where the robot is likely to be unable to pass is specified, the area setting unit 121 may set the place as the restricted area. In addition, the setting may be performed by combining the manual setting and the automatic setting. The area setting unit 121 may divide the map into a plurality of areas by Voronoi division.

The waypoint setting unit 122 sets the waypoints on the map. The waypoints are points through which the robot 200 passes. The waypoints are used for the route planning. For example, the route planning unit 115 sets the waypoints from the departure point to the destination and the order thereof. The route planning unit 115 determines the order of the waypoints that are the passing points. The robot 200 performs autonomous driving to pass through the waypoints in the set order. For example, in a case where the passage branches at a branch point or an intersection, the waypoint setting unit 122 appropriately sets the waypoints at the branch point, the intersection, the corner, and the periphery thereof. In addition, the waypoint setting unit 122 sets the waypoints at a boundary portion of the area.

The waypoint setting unit 122 sets a plurality of waypoints on the map. The waypoint setting unit 122 assigns a waypoint ID to each waypoint. The waypoint setting unit 122 stores the coordinates and the ID of the waypoint in association with each other as the waypoint information. The waypoint information may include an attribute of the waypoint. In addition, the waypoint setting unit 122 may set a charger, the inside of an elevator, an elevator boarding and alighting position, a place to receive a package, a place to mount a package, and a front of an automatic door as the waypoints.

The control device 100 or another computer may set the waypoint by calculation processing, or the user may set the waypoint. Further, after the waypoint is set by the calculation processing, the user may manually adjust the waypoint setting. For example, one or more waypoints may be set by executing a program by a computer such as the control device 100. The user may manually set the waypoint.

By using a program for performing the waypoint setting, the waypoint setting can be easily performed. Specifically, in a case where the computer specifies an intersection or the like based on the architectural drawing data, the map layout, the CAD data, and the BIM data, the waypoint setting unit 122 sets the waypoint at the place. Alternatively, the waypoint setting unit 122 sets the waypoints at the boundary portion between the restricted area and the non-restricted area. An AI model generated by supervised learning or the like can be used for the automatic setting of the waypoint.

Image data indicating the architectural drawing or BIM data is input to a machine learning model. Further, the map data in which the area is set is input to the machine learning model. The machine learning model sets the waypoint by a segmentation algorithm. In addition, the setting may be performed by combining the manual setting and the automatic setting.

Further, the control device 100 includes a robot controller 125. The robot controller 125 controls a plurality of types of robots 200. The robot controller 125 performs control such that the robot 200 passes through the waypoints in the passing order set in the route search. As described above, the route planning unit 115 searches for a route to the destination based on the plurality of waypoints. As a result, the waypoint to be passed through is selected from among the plurality of waypoints registered on the map. Further, the route planning unit 115 determines the passing order of the selected waypoints. The robot is controlled such that the robot 200 sequentially passes through the waypoints to the destination. In addition, the robot controller 125 may control the entry of the robot 200 into the restricted area based on the right of way.

Further, in the present embodiment, the waypoint setting unit 122 sets the waypoint corresponding to the robot 200. The position of the waypoint is different depending on the robot 200. For example, the waypoint setting unit 122 sets the waypoint based on the robot information. The position of the waypoint is different depending on the type of the robot 200, and the like. Alternatively, the waypoint setting unit 122 sets the waypoint based on the transport object information. The position of the waypoint is different depending on the type of the transport object, and the like.

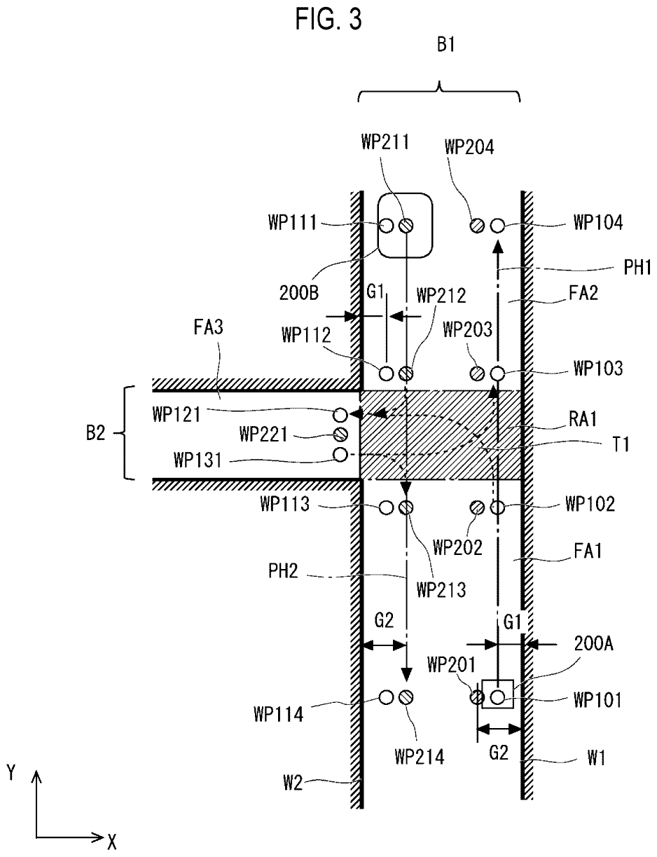

The restricted area, the non-restricted area, and the waypoint set on the map will be described with reference to FIG. 3. FIG. 3 is a plan view schematically showing the map. In FIG. 3, an XY two-dimensional orthogonal coordinate system is shown for clarity of description.

In FIG. 3, a passage B1 is provided along the Y direction. A wall on the +X side defining the passage B1 is a wall W1, and a wall on the −X side is a wall W2. That is, the passage B1 is between the walls W1, W2 shown in the map. In the XY plan view, the walls W1, W2 are straight lines along the Y direction. A branch point T1 that is a three-way junction is provided in the middle of the passage B1. A passage B2 extending in the X direction is connected to the branch point T1. That is, the branch point T1 corresponds to an intersection where the passages B1, B2 intersect. The passage B2 extends from the branch point T1 in the −X direction.

The branch point T1 where the passages B1, B2 intersect is a restricted area RA1. In the passage B1, a −Y side of the restricted area RA1 is a non-restricted area FA1, and a +Y side is a non-restricted area FA2. That is, in the Y direction, the restricted area RA1 is disposed between the non-restricted areas FA1, FA2. In the passage B2, a −X side of the restricted area RA1 is a non-restricted area FA3. In the restricted area RA1, the number of robots that can pass at the same time is limited to one. The restricted area RA1 corresponds to the branch point T1.

In addition, in FIG. 3, two robots 200 are shown, and these are identified as robots 200A, 200B. In addition, in a case where the robots 200A, 200B are not identified, they will be collectively referred to as robot 200. The robots 200A, 200B are different types of robots, and have different outer sizes in the top view (XY plan view). The robot 200A performs autonomous driving along the passage B1 in the +Y direction along a route PH1. The robot 200B performs autonomous driving along the passage B1 in the −Y direction along a route PH2. The routes PH1, PH2 are straight lines along the Y direction.

Here, the robot 200 will be described as performing autonomous driving on the right side of the passage. Therefore, the robot 200A that proceeds in the +Y direction on the passage B1 performs autonomous driving on the wall W1 side of the passage B1. In addition, the robot 200B that proceeds in the −Y direction on the passage B1 performs autonomous driving on the wall W2 side of the passage B1. Of course, the robot 200 may be set to proceed on the left side of the passage.

In the XY plan view, the outer sizes of the robots 200A, 200B are different. Here, in the XY plan view, the robot 200B is larger than the robot 200A. Specifically, in a case where a direction (X direction) orthogonal to the proceeding direction (Y direction) of the robots 200A, 200B is a width direction, the robot 200B is provided to be wider than the robot 200A. In this case, the waypoint setting unit 122 sets the waypoint at different positions between the robots 200A, 200B.

In the passage B2, the waypoints WP101 to WP104 and the waypoints WP111 to WP114 are set for the robot 200A. In the passage B2, the waypoints WP201 to WP204 and the waypoints WP211 to WP214 are set for the robot 200B. As described above, different waypoints are set depending on the robot 200.

The waypoints WP101 to WP104 are passing points in a case where the robot 200A proceeds in the +Y direction on the passage B1. The waypoints WP101 to WP104 are disposed on a straight line parallel to the Y direction. The route PH1 is a straight line passing through the waypoints WP101 to WP104. In a case where the robot 200A performs autonomous driving on the passage B1 in the +Y direction, the robot 200A sequentially passes through the waypoints WP101, WP102, WP103, WP104. The waypoints WP111 to WP114 are passing points in a case where the robot 200A proceeds in the −Y direction on the passage B1. The waypoints WP111 to WP114 are disposed on a straight line parallel to the Y direction. In a case where the robot 200A performs autonomous driving on the passage B1 in the −Y direction, the robot 200A sequentially passes through the waypoints WP111, WP112, WP113, WP114.

The waypoints WP201 to WP204 are passing points in a case where the robot 200B proceeds in the +Y direction on the passage B1. The waypoints WP201 to WP204 are disposed on a straight line parallel to the Y direction. In a case where the robot 200B performs autonomous driving on the passage B1 in the +Y direction, the robot 200B sequentially passes through the waypoints WP201, WP202, WP203, WP204. The waypoints WP211 to WP214 are passing points in a case where the robot 200B proceeds in the −Y direction on the passage B1. The waypoints WP211 to WP214 are disposed on a straight line parallel to the Y direction. The route PH2 is a straight line passing through the waypoints WP211 to WP214. In a case where the robot 200B performs autonomous driving on the passage B1 in the −Y direction, the robot 200B sequentially passes through the waypoints WP211, WP212, WP213, WP214.

Here, the waypoint setting unit 122 determines the waypoint position depending on the outer size of the robot 200. That is, on the map, the position of the waypoint for the robot 200A and the position of the waypoint for the robot 200B are shifted. For example, in the robot 200A having a small outer size in the width direction, the waypoints WP101 to WP104 are set near the wall W1. Here, an interval from the wall W1 to the waypoint WP101 in the X direction is an interval G1. In addition, a distance from the wall W2 to the waypoint WP112 is also the interval G1.

On the other hand, in the robot 200B having a large outer size in the width direction, the waypoints WP201 to WP204 are set away from the wall W1. For example, an interval from the wall W1 to the waypoint WP201 in the X direction is an interval G2. In addition, a distance from the wall W2 to the waypoint WP213 is also the interval G2. The interval G2 is larger than the interval G1. The intervals G1, G2 indicate a distance in the X direction.

As described above, the waypoints are set such that the distance from the wall surface varies depending on the outer size of the robot 200. Therefore, the robots having different sizes can be controlled to pass closer to the wall. Since the distance to the wall surface can be set to an appropriate distance for the routes PH1, PH2, the space such as the passage can be effectively used. For example, in a case where the robot 200A having a small size moves along the waypoints WP201 to WP204, the interval between the wall W1 and the robot 200A is widened. In this case, since the space in the center portion of the passage B1 is narrowed, the passage of a person or the like may be obstructed. On the other hand, in a case where the robot 200B having a large size passes through the waypoint WP201, the robot 200B comes into contact with the wall W1, or the wall W1 enters the virtual bumper of the robot 200B. Therefore, the robot 200B stops or decelerates.

In particular, at a timing when the two robots 200A, 200B pass each other, the space between the two robots 200A, 200B is narrowed. For example, at a timing when the robots 200A, 200B are at the same position in the Y direction, the space between the robots 200A, 200B is narrowed. Therefore, a person cannot overtake the robot 200A or 200B. Therefore, by setting the waypoint depending on the outer size of the robot 200, the waypoint setting unit 122 can effectively use the space. As a result, the robot 200 can efficiently execute the task.

In addition, the area setting unit 121 sets the restricted area RA1 and the non-restricted areas FA1, FA2. Here, the waypoints WP102, WP202 are set on the non-restricted area FA1 side of the boundary between the restricted area RA1 and the non-restricted area FA1. Therefore, in a case where another robot 200 is in the restricted area RA1, the robot 200A waits at the waypoint WP102. That is, after the other robot 200 exits from the restricted area RA1, the robot 200A departs from the waypoint WP102 and enters the restricted area RA1.

Similarly, the waypoints WP112, WP212 are set on the non-restricted area FA2 side of the boundary between the restricted area RA1 and the non-restricted area FA2. Therefore, in a case where another robot 200 is in the restricted area RA1, the robot 200B waits at the waypoint WP212. That is, after the other robot 200 exits from the restricted area RA1, the robot 200B departs from the waypoint WP212 and enters the restricted area RA1.

As a result, the robot 200 can efficiently perform autonomous driving in the restricted area RA1 in which the robot 200 can perform autonomous driving in various directions. In the intersection or the like, it is assumed that the robot 200 performs autonomous driving in various directions by moving straight ahead or turning right or left. Therefore, the intersection is the restricted area RA1 in which the free entry of the robot 200 is restricted. As a result, the number of robots 200 that are present in the restricted area RA1 at the same time can be limited.

The area setting unit 121 sets the intersection or the branch point as the restricted area. Then, the robot 200 to which the right of way is granted by the right-of-way granting unit 123 shown in FIG. 2 can solely enter the restricted area RA1. In other words, in a case where the robot 200 is already in the restricted area RA1, the other robot 200 can enter the restricted area RA1 after the robot 200 in the restricted area RA1 leaves the restricted area RA1. Therefore, the waypoints WP102, WP112, WP202, WP212 at the boundary portion are waiting positions where the robot 200 waits.

The right-of-way granting unit 123 shown in FIG. 2 grants the right of way to the robot 200. The right of way is a resource that allows the robot 200 to pass through the restricted area RA1. The right-of-way granting unit 123 grants the right of way for each robot. Further, the right-of-way granting unit 123 manages the right of way for each restricted area.

The right-of-way granting unit 123 grants the right of way to the robot 200 in response to a request from the robot 200. For example, a case where the robot 200 at the waypoint WP102 moves to the waypoint WP121 will be described. In a case where the robot 200 arrives at the waypoint WP102 or the vicinity thereof, the robot 200 transmits a request signal for requesting the right of way of the restricted area RA1 to the control device 100. In a case where the communication unit 140 of the control device 100 receives the request signal, the right-of-way granting unit 123 grants the right of way of the restricted area RA1 to the robot 200. Specifically, the communication unit 140 transmits the right-of-way granting signal to the robot 200. The right-of-way granting signal includes an area ID or the like of the restricted area where passage is permitted. Alternatively, the right-of-way granting unit 123 may determine whether to grant the right of way. Further, the right-of-way granting unit 123 may manage the order of the robots permitted to pass. For example, the right-of-way granting unit 123 may define the passing order in the order of the request from the robot 200.

The passage B2 extending in the X direction has a narrower passage width than the passage B1. That is, the Y direction size of the passage B2 is smaller than the X direction size of the passage B1. In this case, for the robot 200B having a large outer size, the waypoint WP221 is set at the center of the passage B2 in the width direction. In other words, the robot 200B having a large outer size cannot pass through the passage B2 in a passing manner. Therefore, the non-restricted area FA3 is a one-side passage area for the robot 200B. In this case, the right of way may be granted to the robot 200B to pass through the non-restricted area FA3 as a one-side passage area. That is, in a case where the robot 200B performs autonomous driving in the +X direction, the right-of-way granting unit 123 grants the right of way such that the passage of the robot 200B performing autonomous driving in the −X direction is restricted.

The robot 200A having a small outer size can pass through the passage B2 in a passing manner. Therefore, the waypoints WP121, WP131 are set in the passage B2. The waypoints WP121, WP131, WP221 have the same position in the X direction and different positions in the Y direction. In addition, in a case where the passage B2 has a passage width such that the robots 200B, 200A cannot pass each other, the right-of-way granting unit 123 may grant the right of way to manage the right of way for the robots 200B, 200A.

In addition, in the above description, the waypoint is set at the position corresponding to the outer size of the robot 200, but the waypoint may be set based on information other than the outer size. For example, the waypoint setting unit 122 may determine the position of the waypoint in accordance with the transport object information of the transport object transported by the robot 200. For example, even in the case of the same type of robot 200, the outer size of the mounted transport object may be different. In the XY plan view, in a case where the transport object is larger than the robot 200, the transport object may protrude outside the robot 200. Therefore, the waypoint setting unit 122 may change the position of the waypoint depending on the outer size of the transport object.

The waypoint may be changed depending on the type of the transport object. For example, in a case where there is a transport object that cannot be brought into a predetermined area, the area is a prohibited access area. Since the unclean transport object cannot be brought into the clean area, the clean area is a prohibited area. Alternatively, in a case where a transport object that should not be seen by a person other than the employee is transported, an area where a person other than the employee can enter is a prohibited area. The waypoint setting unit 122 sets the waypoint by excluding the prohibited area. As a result, the route planning unit 115 performs route planning such that the robot 200 bypasses the prohibited area. As a result, the plurality of robots can efficiently and appropriately execute the task.

In addition, the waypoint may be changed depending on the task executed by the robot 200. For example, in a case where the robot 200 is assigned the cleaning task, the security task, or the guidance task, the waypoint is set at a position different from the position of the robot 200 assigned the transport task. As described above, the waypoint is set for the robot 200 assigned the transport task such that the robot 200 moves straight ahead in the passage. On the other hand, the waypoint is set for the robot 200 assigned the cleaning task such that the robot 200 meanders in the passage. For example, since the robot 200 performs autonomous driving in a zigzag manner in the passage, the entire passage can be cleaned. As a result, the plurality of robots can efficiently and appropriately execute the task.

In addition, as described above, the waypoint is set such that the robot 200 assigned the transport task performs autonomous driving along the wall of the passage. In the guidance task or the security task, the waypoint is set such that the robot 200 performs autonomous driving at the center of the passage in the width direction. The robot 200 assigned the guidance task performs autonomous driving at the center of the passage while holding the signboard or the signage. As a result, the user can easily visually recognize the signboard or the signage. As a result, the plurality of robots can efficiently and appropriately execute the task.

In addition, even in the case of the same type of robot 200, the position of the waypoint may be different depending on the task or the type of the robot. For example, the robot that executes the unclean task or the unclean robot cannot enter the clean area. In this case, the clean area is the prohibited area. Therefore, the waypoint setting unit 122 sets the waypoint by excluding the prohibited area. As a result, the route planning is performed such that the unclean robot 200 bypasses the prohibited area. As a result, the plurality of robots can efficiently and appropriately execute the task.

In addition, the waypoint setting unit 122 may set the waypoint depending on the presence or absence of the accessory unit 700 or the type of the accessory unit 700. The position of the waypoint may be different depending on the presence or absence of the accessory unit 700 or the type of the accessory unit 700. In a case where the outer shape is different depending on the accessory unit 700, the waypoint setting unit 122 determines the position of the waypoint depending on the outer shape of the robot 200 including the accessory unit 700.

Further, in the waypoint where the robot 200 turns around, the position of the waypoint may be determined depending on the front-rear direction size and the width direction size of the robot 200. For example, it is assumed that there is a waypoint where the robot 200 turns around in place to change the direction. In this case, the position of the waypoint is determined depending on the larger size of the front-rear direction size and the width direction size. That is, even in a case where the robot 200 turns around in place, the waypoint is a position at which a sufficient distance is taken from the wall surface. Examples of the waypoint where the robot 200 turns around in place include a charging place and an elevator.

The waypoint setting unit 122 can set the waypoint based on at least one of the transport object information, the task information, and the robot information. For example, the waypoint setting unit 122 can set the waypoint corresponding to the transport object. The waypoint setting unit 122 can set the waypoint corresponding to the task. The waypoint setting unit 122 can set the waypoint corresponding to the robot. Of course, the waypoints may not be different for all the robots. That is, the waypoints may be the same in some robots. The waypoints that are available may be registered in accordance with the transport object information, the task information, and the robot information.

Specifically, the waypoint setting unit 122 assigns the waypoint information to each waypoint and records the waypoint information in a database in a memory or the like. The waypoint information includes the waypoint ID, the coordinates, and information indicating the availability. The information indicating the availability may be set in at least one of the transport object information, the task information, and the robot information.

Then, the route planning unit 115 performs the route planning by referring to at least one of the transport object information, the task information, and the robot information. That is, the robot information, the transport object information, and the task information of the robot as a target of the route planning are acquired. As a result, the waypoint group that can be used for the route planning can be selected. That is, the waypoint group that can be used by the route planning unit 115 is different for each robot, each transport object, and each task. Then, the route planning unit 115 extracts a plurality of waypoints through which the robot can efficiently move to the destination from the selected waypoint group. Then, the route planning unit 115 performs the route planning by determining the passing order of the extracted waypoints. The robot controller 125 controls the robot such that the robot 200 passes through the waypoints in the passing order. As a result, the robot 200 performs autonomous driving to the destination along the route connecting the waypoints in the passing order. The plurality of robots can move along the route such that the robots can efficiently and appropriately execute the task.

The control device 100 or the robot 200 may use a machine learning model such as deep learning in the route planning or the driving control. Further, in the detection of the peripheral object or the like, a machine learning model such as deep learning such as a recurrent neural network (RNN) or a convolutional neural network (CNN) may be used.

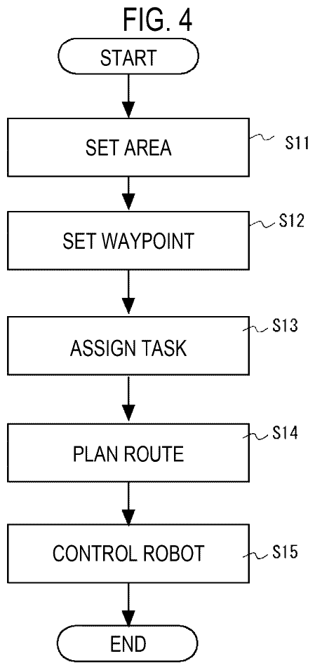

A control method by the control system according to the present embodiment will be described with reference to FIG. 4. FIG. 4 is a flowchart showing a robot control method according to the present embodiment. First, the area setting unit 121 sets the area on the map (S11). As a result, the map is divided into the restricted area and the non-restricted area. In addition, the attribute or the like may be set for each area.

The waypoint setting unit 122 sets a plurality of waypoints (S12). Here, the waypoint setting unit 122 sets the waypoints in the restricted area and the non-restricted area. Further, the waypoint group that is available is registered based on the robot information, the transport object information, and the task information. That is, the position of the waypoint is set to be different depending on the robot or the like.

Next, the task management unit 114 assigns the task to the robot (S13). For example, in a case where the user registers the task to be executed, the task management unit 114 determines the robot that executes the task based on the availability of the robot, the current position, and the like.

Next, the route planning unit 115 performs the route planning (S14). For example, the route planning unit 115 acquires the current position of the robot that executes the task from the robot information storage unit 112. The route planning unit 115 searches for a route from the current position to the via point or the destination. For example, the route planning unit 115 acquires the type of the robot from the robot information. As a result, the waypoint group that is available is selected. Then, the waypoint to be passed through is determined from the waypoint group that is available. Further, the route planning unit 115 determines the passing order of the waypoints. Of course, the waypoints that are available may be set depending on the type of the robot as well as the transport object or the task.

The robot controller 125 controls the robot 200 such that the robot 200 passes through the waypoints in the set passing order (S15). The robot controller 125 controls the robot 200 such that the robot 200 sequentially passes through the waypoints to the destination. The control here may include processing such as the right-of-way granting. As a result, the robot can be appropriately controlled, and thus the task can be efficiently executed.

In addition, a part or all of the processing in the robot 200, the control device 100, and the like described above can be realized as a computer program. Such a program can be stored in various types of non-transitory computer readable media and supplied to the computer. The non-transitory computer readable medium includes various types of tangible recording media. Examples of the non-transitory computer readable medium include a magnetic recording medium (for example, a flexible disk, a magnetic tape, and a hard disk drive), a magneto-optical recording medium (for example, a magneto-optical disk), a CD-read only memory (ROM), a CD-R, a CD-R/W, and a semiconductor memory (for example, a mask ROM, a programmable ROM (PROM), an erasable PROM (EPROM), a flash ROM, and a random access memory (RAM)). In addition, the program may be supplied to the computer by various types of transitory computer readable media. Examples of the transitory computer readable media include electrical signals, optical signals, and electromagnetic waves. The transitory computer readable medium can supply the program to the computer via a wired communication route such as an electric wire and an optical fiber, or a wireless communication route.

The present disclosure is not limited to the embodiment, and can be appropriately modified without departing from the spirit.

What is claimed is:

1. A robot control system that controls a plurality of kinds of autonomous movement robots, wherein:
the robot control system is configured to
set, on a map, a plurality of waypoints serving as candidates for via points of the autonomous movement robots,
search for a route to a destination based on the waypoints, and
control the autonomous movement robots such that the autonomous movement robots sequentially pass through the waypoints to the destination; and
positions of the waypoints are different depending on the autonomous movement robots.

2. The robot control system according to claim 1, wherein the waypoints are set such that a distance from a wall surface shown on the map is different depending on outer sizes of the autonomous movement robots in a top view.

3. The robot control system according to claim 1, wherein:
the autonomous movement robots are transportation robots that transport a transport object; and
the positions of the waypoints are different depending on the transport object.

4. The robot control system according to claim 3, wherein the waypoints are set such that a distance from a wall surface shown on the map is different depending on an outer size of the transport object in a top view.

5. A robot control method that controls a plurality of kinds of autonomous movement robots, the robot control method comprising:
setting, on a map, a plurality of waypoints serving as candidates for via points of the autonomous movement robots;
searching for a route to a destination based on the waypoints; and
controlling the autonomous movement robots such that the autonomous movement robots sequentially pass through the waypoints to the destination,
wherein positions of the waypoints are different depending on the autonomous movement robots.
